(19) United States
(12) Patent Application Publication
(10) Pub. No.: US 2009/0236503 A1
(43) Pub. Date: Sep. 24, 2009

(54) Housing with a sensed power switch

(76) Inventors: Kuo-Hwa Huang, Chung-Ho City (TW); Lung-Yuan Chen, Chung-Ho City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/076,671

(22) Filed: Mar. 21, 2008

(51) Int. Cl. G01J 1/44; H01H 1/00

(52) U.S. Cl. 250/214 SW; 200/502

(57) ABSTRACT

A housing with a sensed power switch includes a shell, a motherboard power switch, and a sensed switch module. The motherboard power switch is located in the shell for turning on or off the computer. The sensed switch module is located in the shell, and has a sensing element and a control circuit. The sensing element is pasted onto the shell and corresponds to a sensing area located outside of the shell. The control circuit is electrically connected with the sensing element and the motherboard power switch. When a sensing object approaches the sensing area, the sensing element outputs a pulse signal to the control circuit. The control circuit outputs a control signal to control the motherboard power switch to turn on or turn off the computer according to the pulse signal.

### BACKGROUND OF THE INVENTION

1. Field of the Invention

The present invention relates to a housing with a sensed power switch. In particular, this invention relates to a housing that uses a sensed power switch to turn on or turn off a computer.

2. Description of the Related Art

Reference is made to FIG. 1, which shows a schematic diagram of the appearance of a housing of the prior art. On the housing 10, there is a pressed switch 12. The pressed switch 12 is electrically connected with a motherboard power switch 14 (referring to FIG. 2) in the housing 10. When the user presses the pressed switch 12, the motherboard power switch 14 is enabled or disabled to turn on or turn off the computer.

Generally, the pressed switch 12 is a mechanical switch. The mechanical switch protrudes to outside of the housing 10, and a hole is located on the housing 10 for being installed with the mechanical switch. However, there is a gap between the protruding mechanical switch and the hole, and dust is easily accumulated on the gap. The dust will affect the electronic signal transmission between mechanical switch 12 and the motherboard power switch 14. Furthermore, water easily permeates into the housing 10 via the gap so that the mechanical switch 12 and the motherboard power switch 14 form a short-circuit.

### SUMMARY OF THE INVENTION

One particular aspect of the present invention is to provide a housing with a sensed power switch that uses a sensed switch to turn on or turn off a computer. The computer power is turned on or turned off via a sensing way.

In the first embodiment, the housing with a sensed power switch includes a shell, a motherboard power switch, and a sensed switch module. The motherboard power switch is located in the shell for turning on or off the computer. The sensed switch module is located in the shell, and has a sensing element and a control circuit. The sensing element is pasted onto the shell and corresponds to a sensing area located outside of the shell. The control circuit is electrically connected with the sensing element and the motherboard power switch. When a sensing object approaches the sensing area, the sensing element outputs a pulse signal to the control circuit. The control circuit controls the motherboard power switch to turn on or turn off the computer according to the pulse signal.

In the second embodiment, the housing with a sensed power switch further includes a concave trough located at outside of the shell, and the sensing area is located in the concave trough so that there is a distance between the sensing area and the sensing object. Therefore, an error operation cause by a non-sensing object is avoided.

The housing with a sensed power switch of the present invention utilizes the sensing element to control the motherboard power switch to turn on or turn off the computer when the sensing object approaches the sensing area. The present invention uses the sensed switch pasted in the housing to replace the protruding mechanical switch. The housing does not require a hole so that the time for producing the hole on the housing is reduced. Furthermore, because the pre present invention uses the sensed switch pasted in the housing to replace the protruding mechanical switch, the housing does not require a hole so that there is no gap on the housing. The dust-proof and the water-proof effects are achieved. It is easy for the user to turn on or turn off the computer.

For further understanding of the invention, reference is made to the following detailed description illustrating the embodiments and examples of the invention. The description is for illustrative purpose only and is not intended to limit the scope of the claim.

### BRIEF DESCRIPTION OF THE DRAWINGS

The drawings included herein provide a further understanding of the invention. A brief introduction of the drawings is as follows:

FIG. 1 is a schematic diagram of the appearance of a housing of the prior art;

FIG. 2 is a schematic diagram of the power switch function of the computer of the prior art;

FIG. 3 is a schematic diagram of the appearance of the first embodiment of the present invention;

FIG. 4 is a schematic diagram of the appearance of the second embodiment of the present invention;

FIG. 4A is an amplified schematic diagram of part of the concave trough located on the shell of the second embodiment of the present invention;

FIG. 5 is a block diagram of the function of the present invention;

FIG. 6 is a circuit diagram of the present invention; and

FIG. 7 is a schematic diagram of the sensing element pasted on the front side board in the housing.

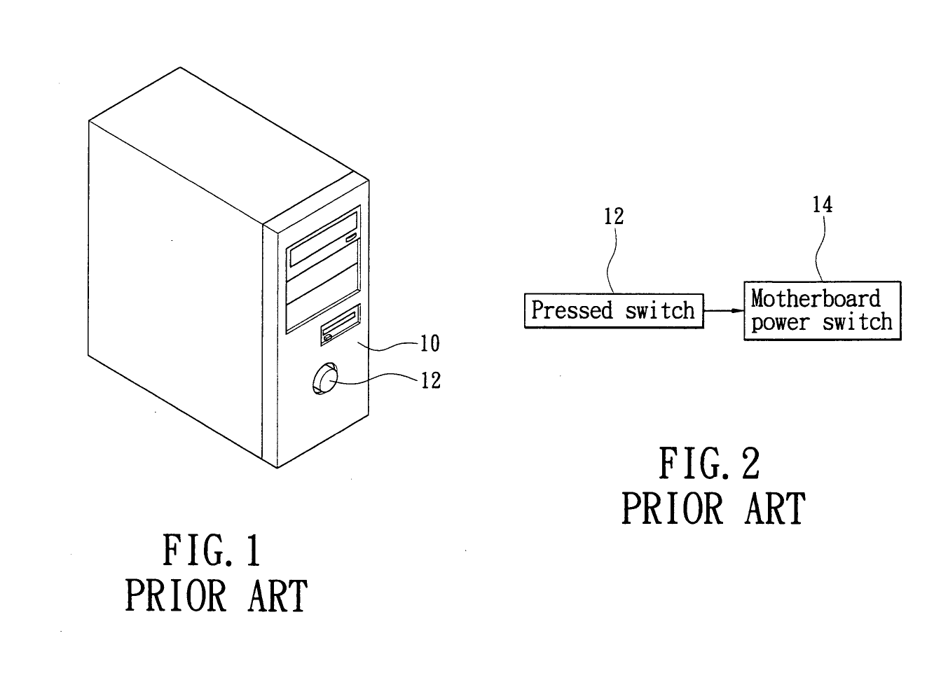

### DETAILED DESCRIPTION OF THE PREFERRED EMBODIMENTS

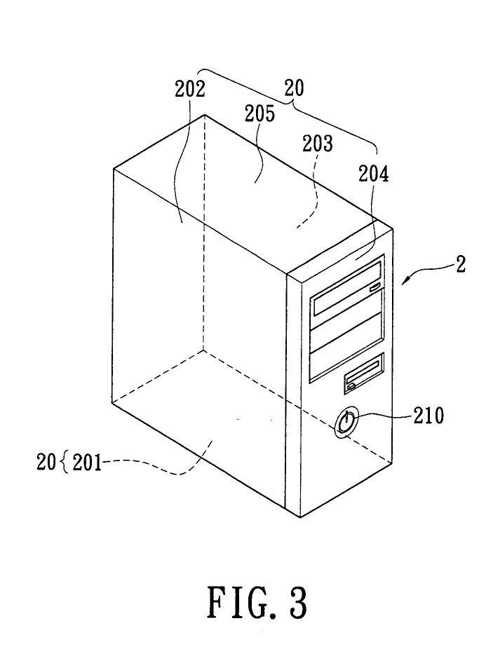

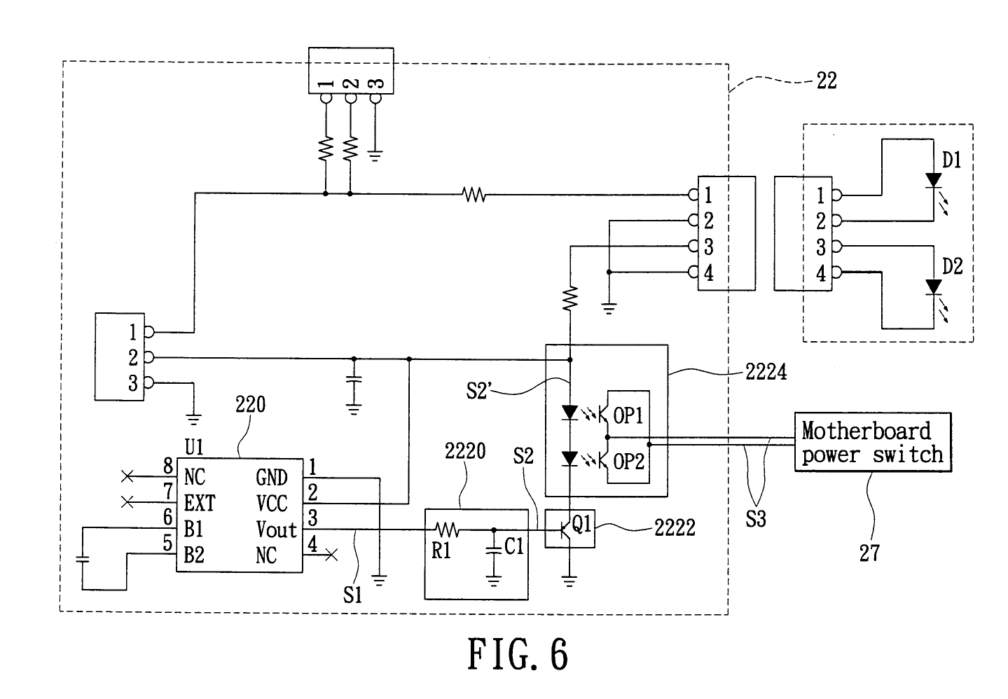

Reference is made to FIG. 3, which shows a schematic diagram of the appearance of the first embodiment of the present invention. The housing 2 with a sensed power switch is a housing for a desktop PC, a portable computer, a variety of computer systems, or a DVD player, etc. The housing 2 has a shell 20. The shell 20 includes left side board 202, a right side board 203, a front side board 204, a top board 205 and a bottom board 201. A sensing area 210 can be located at one of the left side board 202, the right side board 203, the front side board 204 and the top board 205 of the shell 20. In this embodiment, the sensing area 210 is located on the front side board 204 of the shell 20. The sensing area 210 has a transparent power symbol. Furthermore, LEDs D1, D2 (referring to FIG. 6) are located at the inside of the front board 204 and correspond to the sensing area 210 for illuminating the sensing area 210. When the computer is turned off, the LEDs D1, D2 are in a slight-brightness status for showing the location of the sensing area 210. When the computer is turned on, the LEDs D1, D2 are in a highest brightness status for showing the location of the sensing area 210.

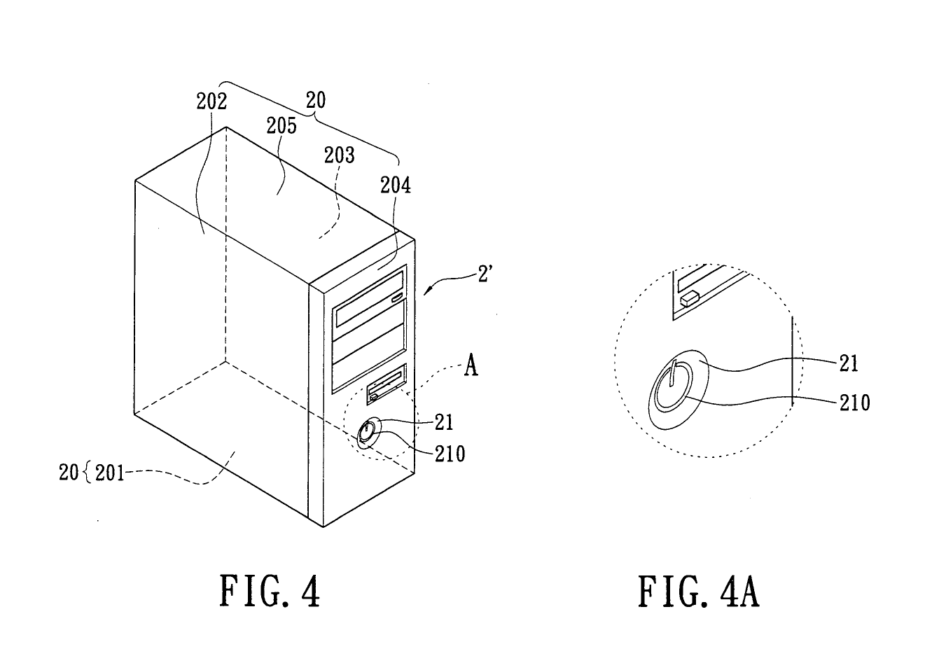

Reference is made to FIGS. 3 and 4. FIG. 4 shows the housing 2′ with a sensed power switch of the second embodiment of the present invention. The components that are the same as ones of the first embodiment are labeled with the same symbols. The difference between the second embodiment and the first embodiment is that the housing 2′ with a sensed power switch further includes a concave trough 21 located at outside of the shell, and the sensing area 210 is located in the concave trough 21 so that there is a distance between the sensing area 210 and the sensing object. Thereby, an error operation cause by a non-sensing object is avoided.

The second embodiment is illustrated in detail. The housing 2′ with a sensed power switch has a shell 20. A concave trough 21 can be located at one of the left side board 202, the right side board 203, the front side board 204, and the top board 205 of the shell 20. In this embodiment, the concave trough 21 is located on the front side board 204 of the shell 20. A sensing area is located in the concave trough 21. The sensing area 210 has a transparent power symbol, as shown in FIG. 4A which is an amplified schematic diagram of part of the concave trough 21 located on the shell 20. Furthermore, LEDs D1, D2 (referring to FIG. 6) are located at the inside of the front board 204 and correspond to the concave trough 21 for illuminating the sensing area 210. When the computer is turned off, the LEDs D1, D2 are in a slight-brightness status for showing the location of the sensing area 210. When the computer is turned on, the LEDs D1, D2 are in a highest brightness status for showing the location of the sensing area 210.

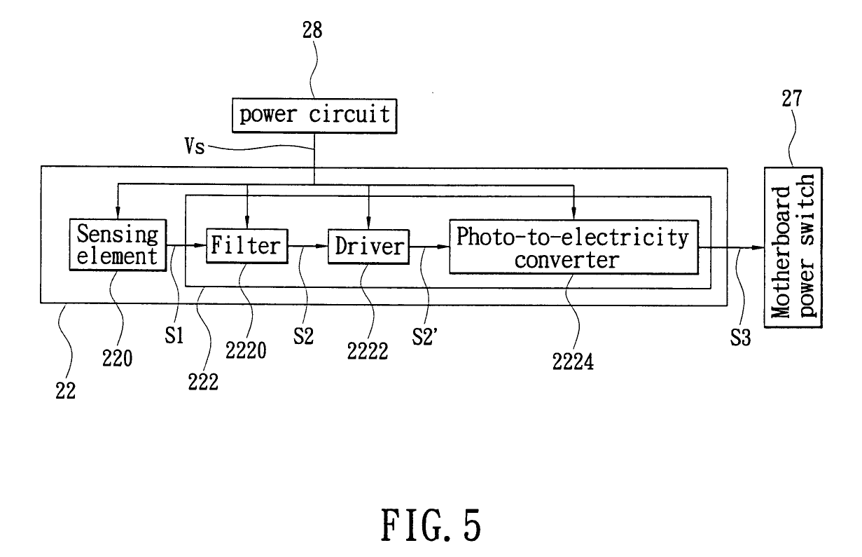

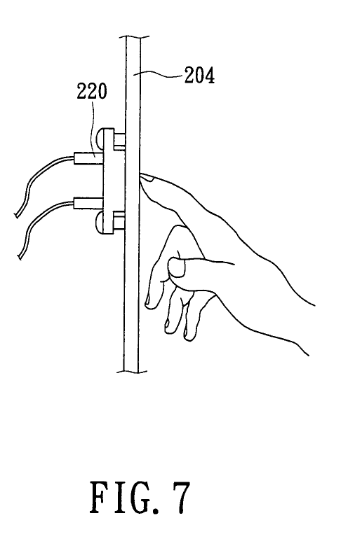

Reference is made to FIGS. 4 and 5. FIG. 5 shows the block diagram of the function of the second embodiment of the present invention. The circuit block includes a motherboard power switch 27, a sensed switch module 22 and a power circuit 28. The motherboard power switch 27 is located in the shell 20 for turning on or off the computer. The sensed switch module 22 is located in the shell 20, and has a sensing element 220 and a control circuit 222. The sensing element 220 is pasted onto the inside of the front side board 204 (referring to FIG. 7) of the shell 20 and corresponds to the sensing area 210 located in the concave trough 21 on the outside of the front side board 204 of the shell 20. The control circuit 222 is electrically connected with the sensing element 220 and the motherboard power switch 27. When a sensing object (not labeled) approaches the sensing area 210, the sensing element 220 outputs a pulse signal S1 to the control circuit 222. The control circuit 222 outputs a control signal S3 to controls the motherboard power switch 27 to turn on or turn off the computer according to the pulse signal S1.

Reference is made to FIGS. 4 and 5 again. The sensing element 220 is a capacitor sensed triggering switch. The control circuit 222 includes a filter 2220, a driver 2222 and a photo-to-electricity converter 2224. The filter 2220 is connected with the sensing element 220. The filter 2220 receives the pulse signal S1 and filters the pulse signal S1 to form a DC signal S2. The filter 2220 is a low-pass filter. The driver 2222 is connected with the filter 2220 for amplifying the DC signal S2. The photo-to-electricity converter 2224 is connected with the driver 2222 and the motherboard power switch 27. The amplified DC signal S2′ will enable the photo-to-electricity converter 2224 to generate the control signal S3 for the motherboard power switch 27. Moreover, the power circuit 28 provides the operation voltage Vs to the sensing element 220, the filter 2220, the driver 2222 and the photo-to-electricity converter 2224.

Reference is made to FIGS. 5 and 6. FIG. 6 shows the circuit diagram of the present invention. The sensing element 220 is a sensing chip U1 with a NT-300-P-PH-B-5V type number. The filter 2220 is a low-pass filter and is composed of a resistor R1 and a capacitor C1. The driver 2222 is a PNP transistor Q1. The photo-to-electricity converter 2224 is composed of two photo couplers OP1, OP2 that are connected in serial.

When a sensing object (not labeled) approaches the sensing chip U1, the sensing chip U1 outputs the pulse signal S1 to the filter 2220 via the output terminal Vout. The filter 2220 filters out the high frequency noise of the pulse signal S1 to generate the DC signal S2. The base terminal of the PNP transistor Q1 is connected with the output terminal of the filter 2220. The emitter terminal of the PNP transistor Q1 is connected with the photo-to-electricity converter 2224, and the collector terminal of the PNP transistor Q1 is connected with a grounding terminal. The base terminal of the PNP transistor Q1 is used as an input terminal, and the emitter terminal of the PNP transistor Q1 is used as an output terminal. Therefore, the PNP transistor is used as an emitter coupler. The emitter coupler has a high current gain for amplifying the DC signal S2. The amplified DC signal S2′ flows through the two photo couplers OP1, OP2 that are connected in serial to enable the photo couplers OP1, OP2. The enabled photo couplers OP1, OP2 generate the control signal S3 and the control signal S3 is transmitted to the motherboard power switch 27. The motherboard power switch 27 turns on or turns off the computer according to the control signal S3. Furthermore, the photo couplers OP1, OP2 can separate the sensing switch module 22 and the motherboard power switch 27 to prevent the sensing switch module 22 and the motherboard power switch 27 from affecting each other due to both are connected to the same grounding.

Reference is made to FIGS. 3, 4 and 6. When the computer is turned off, the LEDs D1, D2 for illuminating the sensing area 210 are enabled in a slight brightness status to show the location of the sensing area 210. When the computer is turned on, the LEDs D1, D2 are enabled in a highest brightness status to show the location of the sensing area 210.

The housing with a sensed power switch of the present invention utilizes the sensing element to control the motherboard power switch to turn on or turn off the computer when the sensing object approaches the sensing area. The present invention uses the sensed switch pasted in the housing to replace the protruding mechanical switch. The housing does not require a hole so that the time for producing the hole on the housing is reduced. Furthermore, because the pre present invention uses the sensed switch pasted in the housing to replace the protruding mechanical switch, the housing does not require a hole so that there is no gap on the housing. The dust-proof and the water-proof effects are achieved. It is easy for the user to turn on or turn off the computer.

The description above only illustrates specific embodiments and examples of the invention. The invention should therefore cover various modifications and variations made to the herein-described structure and operations of the invention, provided they fall within the scope of the invention as defined in the following appended claims.

What is claimed is:

1. A housing with a sensed power switch, comprising:
a shell having a sensing area that is located on the shell's outer surface;
a motherboard power switch located inside the shell for turning on or off a computer, and
a sensed switch module located inside the shell having a sensing element and a control circuit, wherein the sensing element is pasted onto the shell and corresponds to the sensing area, and the control circuit is electrically connected with the sensing element and the motherboard power switch;
wherein the sensing element outputs a pulse signal to the control circuit when a sensing object approaches the sensing area, and the control circuit controls the motherboard power switch to turn on or turn off the computer according to the pulse signal.

2. The housing with a sensed power switch as claimed in claim 1, wherein the shell includes a left side board, a right side board, a top board, a bottom board and a front side board.

3. The housing with a sensed power switch as claimed in claim 2, wherein the sensing area is located at the left side board, the right side board, the top board or the front side board.

4. The housing with a sensed power switch as claimed in claim 3, wherein the sensing element is a capacitor sensed triggering switch.

5. The housing with a sensed power switch as claimed in claim 3, wherein the control circuit comprises:
a filter connected with the sensing element, wherein the filter converts the pulse signal into a DC signal;
a driver connected with the filter for amplifying the DC signal; and
a photo-to-electricity converter connected with the driver and the motherboard power switch, wherein the photo-to-electricity converter transmits the amplified DC signal to the motherboard power switch.

6. The housing with a sensed power switch as claimed in claim 5, wherein the filter is a low-pass filter.

7. The housing with a sensed power switch as claimed in claim 5, further comprising a power circuit for providing an operation voltage to the sensing element, the filter, the driver and the photo-to-electricity converter.

8. The housing with a sensed power switch as claimed in claim 3, further comprising at least one LED located in the shell for illuminating the sensing area.

9. The housing with a sensed power switch as claimed in claim 1, wherein the computer is a desktop PC or a portable computer.

10. A housing with a sensed power switch, comprising:
a shell, wherein a concave trough is located on the shell's outer surface, and
a sensing area is located in the concave trough;
a motherboard power switch located in the shell for turning on or off a computer, and
a sensed switch module located in the shell and having a sensing element and a control circuit, wherein the sensing element is pasted onto the shell and corresponds to the sensing area, and the control circuit is electrically connected with the sensing element and the motherboard power switch;
wherein the sensing element outputs a pulse signal to the control circuit when a sensing object approaches the sensing area, and the control circuit controls the motherboard power switch to turn on or turn off the computer according to the pulse signal.

11. The housing with a sensed power switch as claimed in claim 10, wherein the shell includes a left side board, a right side board, a top board, a bottom board and a front side board.

12. The housing with a sensed power switch as claimed in claim 11, wherein the sensing area is located in the concave trough on the left side board, the right side board, the top board or the front side board.

13. The housing with a sensed power switch as claimed in claim 12, wherein the sensing element is a capacitor sensed triggering switch.

14. The housing with a sensed power switch as claimed in claim 12, wherein the control circuit comprises:
a filter connected with the sensing element, wherein the filter converts the pulse signal into a DC signal;
a driver connected with the filter for amplifying the DC signal; and
a photo-to-electricity converter connected with the driver and the motherboard power switch, wherein the photo-to-electricity converter transmits the amplified DC signal to the motherboard power switch.

15. The housing with a sensed power switch as claimed in claim 14, wherein the filter is a low-pass filter.

16. The housing with a sensed power switch as claimed in claim 14, further comprising a power circuit for providing an operation voltage to the sensing element, the filter, the driver and the photo-to-electricity converter.

17. The housing with a sensed power switch as claimed in claim 12, further comprising at least one LED located in the shell for illuminating the sensing area in the concave trough.

18. The housing with a sensed power switch as claimed in claim 10, wherein the computer is a desktop PC or a portable computer.
